(19) United States
(12) Patent Application Publication
(10) Pub. No.: US 2016/0076390 A1
(43) Pub. Date: Mar. 17, 2016

(54) MOUNTING AND SEALING ARRANGEMENT FOR A GUIDE VANE OF A GAS TURBINE

(71) Applicant: ALSTOM Technology Ltd, Baden (CH)

(72) Inventors: Robert MARMILIC, Rieden (CH); Sergey SHCHUKIN, Mellingen (CH)

(21) Appl. No.: 14/837,078

(22) Filed: Aug. 27, 2015

(30) Foreign Application Priority Data
Sep. 15, 2014 (EP) 14184727.7

(51) Int. Cl. F01D 9/04; F01D 25/12

(52) U.S. Cl. CPC F01D 9/042; F01D 9/041; F01D 25/12; F05D 2220/32; F05D 2240/12; F05D 2240/55; F05D 2240/81; F05D 2260/201

(57) ABSTRACT

The invention relates to a mounting and sealing arrangement for a guide vane of a gas turbine, which includes a vane carrier for carrying said vanes in a ring-like arrangement, whereby the vanes each comprise an airfoil and an outer diameter platform. The thermal stress is reduced and lifetime improved by providing a separate intermediate mounting element between the vane carrier and the outer diameter platform of each of the vanes, and mounting the intermediate mounting element with an outer side on the vane carrier, whereby the intermediate mounting element abuts with an inner side on the outer diameter platform in a sealing fashion.

### CROSS-REFERENCE TO RELATED APPLICATIONS

This application claims priority to EP Application No. 14184727.7 filed Sep. 15, 2014, the contents of which are hereby incorporated in its entirety.

### TECHNICAL FIELD

The present invention relates to the technology of gas turbines. It refers to a mounting and sealing arrangement for a guide vane of a gas turbine according to the preamble of claim 1.

### BACKGROUND

In a gas turbine the hot gas coming from the combustor flows through a turbine section, where alternating rings of running blades mounted on a rotor and guide vanes mounted on a vane carrier at the inner casing of the turbine are arranged. There are various possibilities of mounting the vanes on said vane carrier.

Cantilever design vanes are attached to the casing via outer radii platform formed as a box (see for example document U.S. Pat. No. 8,292,580 B2). Such design leads to inducing of high temperature gradient over the platform box and hence, to high thermal stresses. In its turn it leads to part cyclic life shortage.

Additionally, the circumferentially machined casing-vane platform surfaces are difficult to fit to each other due to relatively high shape tolerances causing the platform-casing gaps opening.

### SUMMARY

It is an object of the present invention to avoid the difficulties of prior art vane attachments.

It is another object of the invention to reduce thermal gradients in turbine guide vanes (also called vane), thereby increasing part life time and reduce cooling air leakage and finally improve gas turbine performance.

These and other objects are obtained by a vane mounting and sealing arrangement according to claim 1.

Various embodiments of the invention are claimed in the dependent Claims.

The mounting and sealing arrangement according to the invention for a vane of a gas turbine, which gas turbine comprises a vane carrier for carrying a plurality of said vanes in a ring-like arrangement, whereby said vanes each comprise an airfoil and an outer diameter platform, is characterized in that a separate intermediate mounting element is provided between said vane carrier and said outer diameter platform of each of said vanes, and that said intermediate mounting element is mounted with an outer side on said vane carrier and abuts with an inner side on said outer diameter platform in a sealing fashion.

The mounting element abuts with the inner side on said outer diameter platform in a sealing fashion to reduce or avoid any loss of cooling air between the two elements.

An embodiment of the mounting and sealing arrangement according to the invention is characterized in that said vanes are attached to said intermediate mounting element.

Specifically, said vanes are attached by a fixation means provided on the outer side of said outer diameter platform. The fixation means may for example be in the form of two ears arranged on one side of and projecting from the outer diameter platform one behind the other in circumferential direction, or in the form of a fir-tree.

Another embodiment of the mounting and sealing arrangement according to the invention is characterized in that said intermediate mounting element is part of a ring or a ring segment, that said outer side of said intermediate mounting element is curved in accordance with the ring structure, and that said inner side comprises a flat section for each of said vanes such that said abutment between said inner side and said outer diameter platform takes place in a plane. In effect, the inner side has a polygonal form.

A further embodiment of the mounting and sealing arrangement according to the invention is characterized in that said intermediate mounting element encloses a cavity, which receives cooling air supplied from the vane carrier side.

Specifically, said cooling air is supplied through a bore in said vane carrier.

Another embodiment of the mounting and sealing arrangement according to the invention is characterized in that said intermediate mounting element is provided on its inner side with a circumferential sealing groove, which receives a circumferential seal for sealing said intermediate mounting element against a sealing surface on said outer diameter platform.

A further embodiment of the mounting and sealing arrangement according to the invention is characterized in that said circumferential seal has the form of a corrugated metal strip.

Alternatively, said circumferential seal may have the form of a C-shaped metal strip.

Another embodiment of the mounting and sealing arrangement according to the invention is characterized in that said intermediate mounting element is made of a single material. Especially, said intermediate mounting element may be a moulded component.

Just another embodiment of the mounting and sealing arrangement according to the invention is characterized in that said intermediate mounting element is made of at least two different materials. This allows an optimization of the component with regard to its thermal loading.

Specifically, said intermediate mounting element comprises two separate parallel annular and circumferential or segmented sidewalls made of a first material suitable for a first operating temperature, which are connected by equidistant transverse webs made of a second material suitable for a second operating temperature higher than said first operating temperature, such that each of said vanes is mounted between two adjacent webs.

A further embodiment of the mounting and sealing arrangement according to the invention is characterized in that an impingement plate is provided for each of said vanes just above said outer diameter platform for impingement cooling of said outer diameter platform.

Another embodiment of the mounting and sealing arrangement according to the invention is characterized in that said intermediate mounting elements are each provided with hooks for mounting said intermediate mounting elements on said vane carrier.

Another embodiment provides a gas turbine comprising a mounting and sealing element as described above, a vane carrier and a plurality of vanes carried on the vane carrier in a ring-like arrangement, whereby said vanes each comprise an airfoil and an outer diameter platform.

### BRIEF DESCRIPTION OF THE DRAWINGS

The present invention is now to be explained more closely by means of different embodiments and with reference to the attached drawings.

FIG. 1 shows an arrangement of a gas turbine vane with an intermediate mounting element according to an embodiment of the invention;

FIG. 2 shows various forms of seals used in an arrangement according to FIG. 1;

FIG. 3 shows in a perspective view the upper part with outer diameter platform and fixing elements of the vane mounted in FIG. 1;

FIG. 4 shows in a perspective view an embodiment of an intermediate mounting element according to the invention moulded in one piece and provided with separate cavities for each vane to be mounted;

FIG. 5 shows in a perspective view another embodiment of an intermediate mounting element according to the invention, which comprises two different materials for sidewalls and transverse webs;

FIG. 6 shows in perspective views seals similar to FIG. 2;

FIG. 7 shows in a perspective view the upper part with outer diameter platform and fixing elements of a vane similar to FIG. 3 with an open airfoil;

FIG. 8 shows in a perspective view the upper part with outer diameter platform and a fir-tree fixation of another kind of vane, which may be used with the invention;

FIG. 9 shows an intermediate mounting element suitable for the vane of FIG. 8;

FIG. 10 shows an arrangement of a gas turbine vane with an intermediate mounting element and adjacent heat shield according to another embodiment of the invention, where the intermediate mounting element is open at the outside;

FIG. 11 shows a possible form of an intermediate ring with circular outer side and polygonal inner side; and

FIG. 12 shows in a perspective view the upper part with outer diameter platform and fixing elements of the vane according to FIG. 3 equipped with an impingement plate for impingement cooling of the outer diameter platform.

### DETAILED DESCRIPTION

A basic idea behind the invention is to reduce thermal stresses and reduce cooling air leakage in gas turbine guide vanes by means of implementation of:
1) A ‘flat’ outer diameter guide vane platform attached to suitable intermediate segments, which are mounted into the turbine casing (vane carrier);
2) Specific (especially E-type or W-type) seals in between the outer diameter vane platform and said intermediate mounting segments.

Currently used guide vanes, on the other hand, are often equipped with boxes placed at outer diameter platforms forming the hot gas flow path and providing the vane attachment to the turbine casing (vane carrier).

Temperature gradients, which are high for the prior art box design, are supposed to be reduced by introduction of the ‘flat’ outer diameter platform.

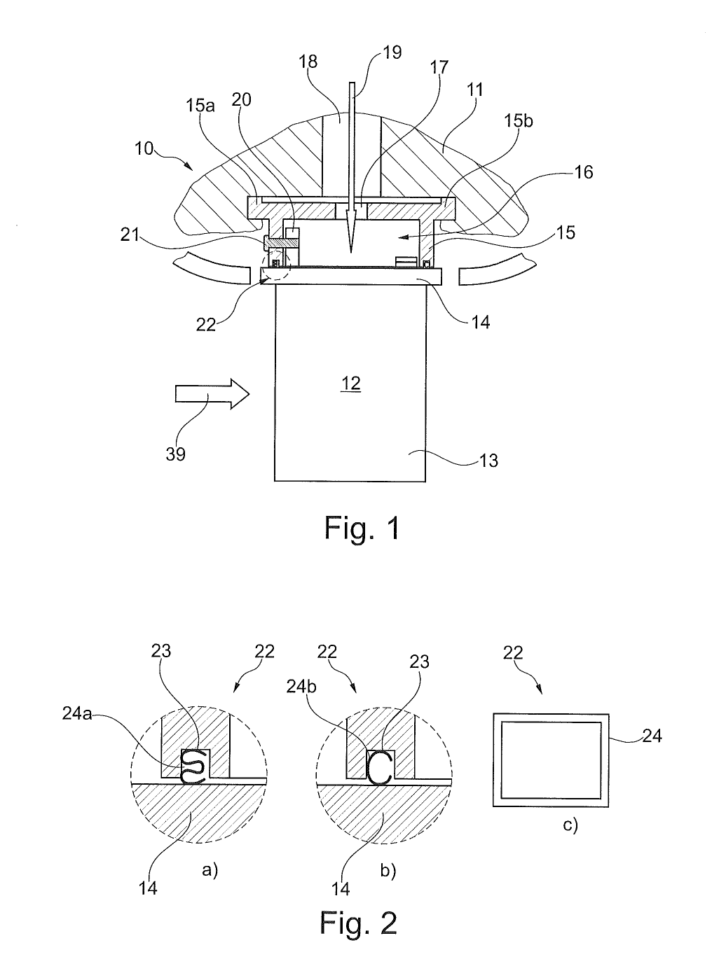

A first embodiment of the configuration according to the invention is presented in FIG. 1, which gives a detailed view of one ring of gas turbine vanes 12 crossing the path of hot gas 39 within said gas turbine 10. The single vane 12 projects with an airfoil 13 in a radial direction into said hot gas path 39. The airfoil 13 is bordered at an outer diameter (or radius) by means of an outer diameter platform 14, which at the same time is part of the outer wall of the hot gas path 39.

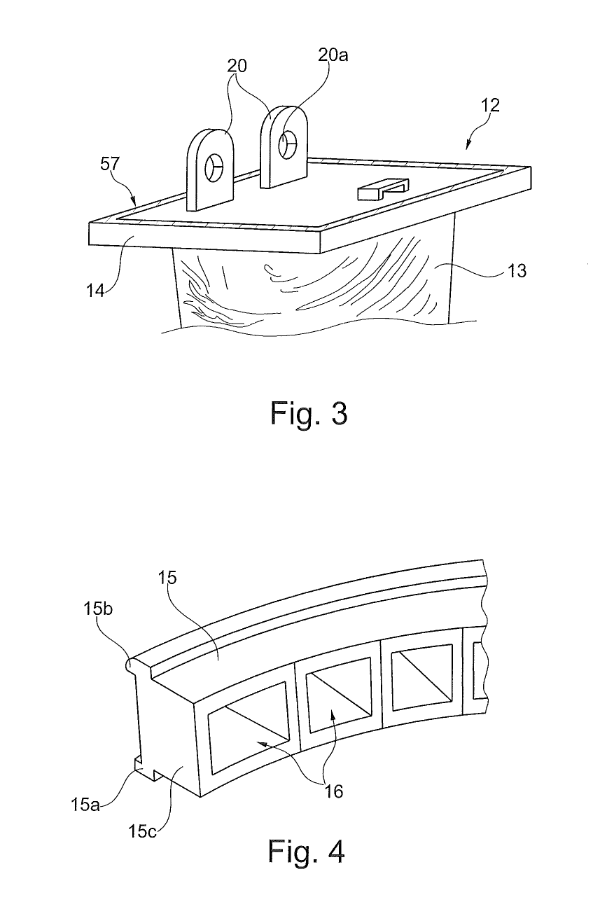

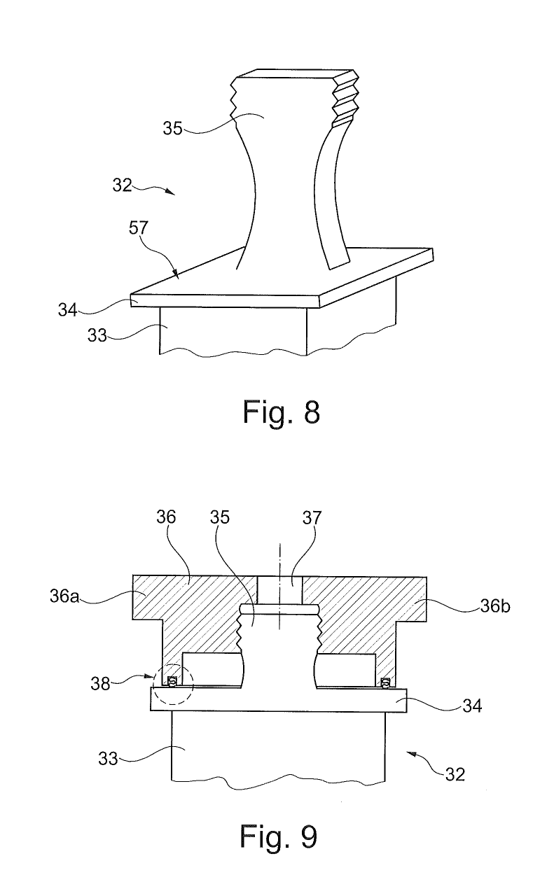

Vane 12 is fixed to an intermediate mounting element 15, which itself is mounted on a vane carrier 11 by means of two hooks 15a and 15b. Intermediate mounting element 15 has a cavity 16, which is open to but sealed against the vane platform side (outer diameter platform 14) by means of a sealing arrangement 22 (see FIG. 2). Intermediate mounting element 15 further has an opening 17 at the upper side, through which cooling air 19, which is supplied through bore 18 in vane carrier 11, can enter the cavity 16. Fixation of vane 12 to intermediate mounting element 15 is done by two fixing elements 20 on the outer side of outer diameter platform 14 (see details in FIG. 3) with bolts extending through respective holes 20a in said fixing elements 20. An alternative fixation means is shown in FIG. 8 (fixation 35 rather than fixing element 20).

For sealing the intermediate mounting element 15 (and the cavity 16) against the outer diameter platform 14 of vane 12 a circumferential sealing groove 23 (FIG. 2) is provided at said intermediate mounting element 15 in the plane facing outer diameter platform 14. According to FIG. 2, sealing groove 23 receives a seal, which may have the form (profile) of a corrugated metal strip (seal 24a in FIG. 2(a)) or a C-shape (seal 24b FIG. 2(b). Especially, the seal 24 may be in the form of a closed (rectangular) ring, as shown in FIG. 2(c).

FIG. 3 shows in a perspective view the upper part with outer diameter platform 14 and fixing elements 20 of the vane 12 mounted in FIG. 1. It can be seen that outer diameter platform 14 has on its outer side a plane circumferential sealing surface 57, which closes sealing groove 23 in the adjacent intermediate mounting element 15.

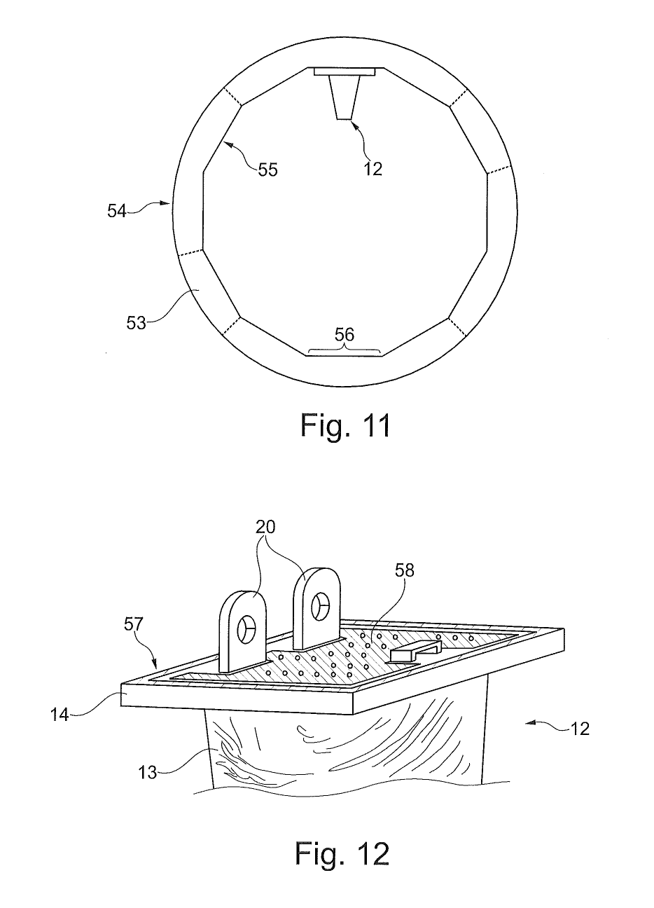

According to FIG. 4, the intermediate mounting element 15 may have the form of a moulded one-piece half-ring or ring segment receiving a plurality of vanes 12. In this case (see FIG. 11), the intermediate mounting element is part of an intermediate ring 53 or ring segment, whereby the outer side 54 of said intermediate mounting element or ring 53 is curved in accordance with the ring structure of the ring or ring segment, and the inner side 55 is of polygonal shape and comprises a flat section 56 for each of said vanes 12, such that the abutment between said inner side 55 and the outer diameter platform 14 of vane 12 takes place in a plane. As shown in FIG. 4, the cavities 16 in intermediate mounting element or ring 15 may be separated by separating walls 15c.

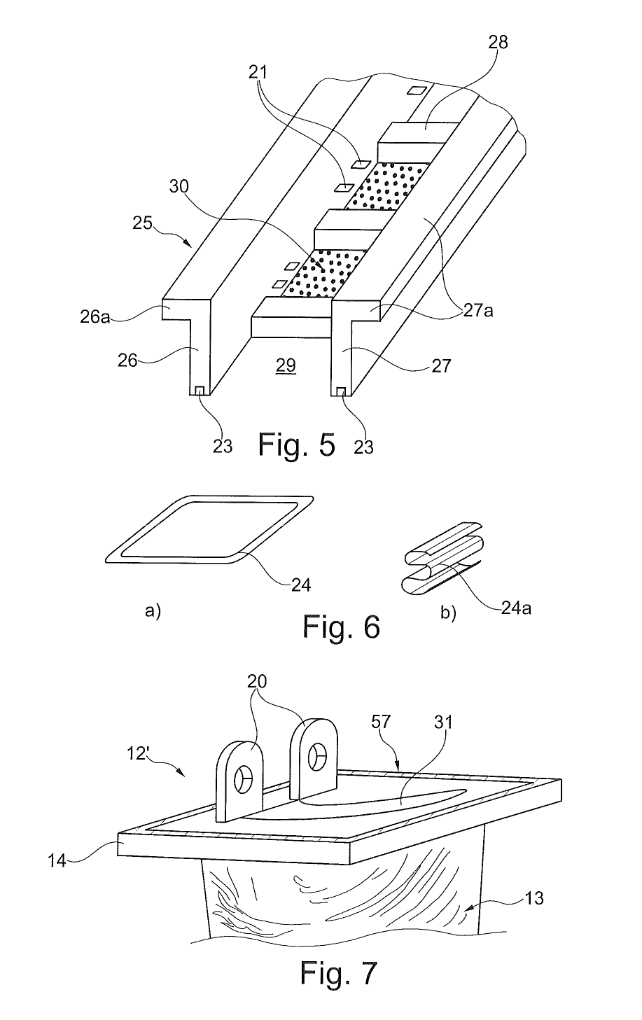

FIG. 5 shows another embodiment of the intermediate mounting element or segment according to the invention. The intermediate mounting element or segment 25 of FIG. 5 has a segment design with incorporated impingement plate 30 to provide cooling of outer diameter vane platform 14 and airfoil 13 in case of a vane 12′ (FIG. 7), where an opening 31 to the interior of airfoil 13 is provided in the outer diameter platform 14.

In the case of FIG. 5, the intermediate mounting element 25 is made of at least two different materials. It comprises two separate parallel annular and circumferential or segmented sidewalls 26, 27 made of a first material suitable for a first operating temperature, which sidewalls 26, 27 are connected by equidistant transverse webs 28 made of a second material suitable for a second operating temperature higher than said first operating temperature. The second material, which is in contact with the gas, may be a Hastelloy® X material, while the first material may be a cheaper material. The webs 28 are so arranged that adjacent webs define a cavity 29 and receive an impingement plate 30 for each vane 12, 12′, which is mounted between two adjacent webs 28. The seals 24, 24a (FIG. 6) may be the same as for the embodiment of FIG. 1.

FIG. 8 is presenting a different kind of vane attachment of a vane 32 with airfoil 33 and outer diameter platform 34 and a (fir-tree) fixation 35 to an intermediate mounting element or segment 36 with suitable hooks 36a and 36b according to FIG. 9. There is the same idea behind this configuration, i.e. to split the “hot” part of the vane 32 (leading edge and trailing edge of the airfoil 33) from the “cold” attachment part, and thus reduce the thermal stresses in those parts of the airfoil 33 most prone to LCF cracking. Again, a sealing arrangement 38 of the kind already described is used between intermediate mounting element 36 and outer diameter platform 34. Furthermore, an opening 37 in the intermediate mounting element 36 gives access to the interior for cooling air.

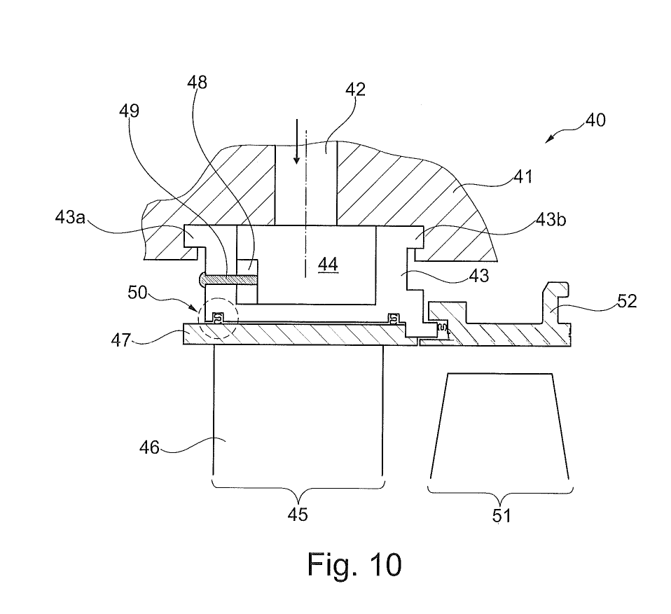

FIG. 10 shows a variant of a possible turbine stage layout of a gas turbine 40 including a blade 51 and stator heat shield 52. The vane 45 with its airfoil 46 and outer diameter platform 47 is attached to intermediate mounting element 43 with a sealing arrangement 50 of the kind already shown. Vane 45 is fixed to intermediate mounting element 43 by means of bolts 49 and fixing elements 48 as explained before. Intermediate mounting element 43, which is in this case open to the other side, has suitable hooks 43a and 43b and encloses a cavity 44, which can be cooled through bore 42 in the vane carrier 41.

Finally, FIG. 12 makes clear that an impingement plate 58 may be directly arranged on the upper side of outer diameter platform 14 of vane 12.

In summary
a central idea here is to split all “hot” from all “cold” walls by means of separate “boxes”, especially in form of intermediate rings/segments; and
only “cold” part of the “hot” vanes is fixation part; this cold part could be fixed either on the “boxes” or directly to the casing/or other carrier.

The main advantages are:
improved leakage control (“2D” sealing)
reduced thermal stress
simplified assembly.

A gas turbine normally comprises a compressor, a combustor and a turbine. The turbine section contains at least one set (stage) of vanes supported on a vane carrier.

1. A mounting and sealing arrangement for a vane of a gas turbine, which includes a vane carrier for carrying a plurality of said vanes in a ring-like arrangement, wherein said vanes each include an airfoil and an outer diameter platform, said arrangement comprising a separate intermediate mounting element is provided between said vane carrier and said outer diameter platform of each of said vanes, and that said intermediate mounting element is mounted with an outer side on said vane carrier and abuts with an inner side on said outer diameter platform in a sealing fashion.

2. The mounting and sealing arrangement as claimed in claim 1, wherein said vanes are attached to said intermediate mounting element.

3. The mounting and sealing arrangement as claimed in claim 2, wherein said vanes are attached by a fixation means provided on the outer side of said outer diameter platform.

4. The mounting and sealing arrangement as claimed in claim 3, wherein the fixation means has the form of ears or a fir tree.

5. The mounting and sealing arrangement as claimed in claim 1, wherein said intermediate mounting element is part of a ring or a ring segment, that said outer side of said intermediate mounting element is curved in accordance with the ring structure, and that said inner side comprises a flat section for each of said vanes such that said abutment between said inner side and said outer diameter platform takes place in a plane.

6. The mounting and sealing arrangement as claimed in claim 1, wherein said intermediate mounting element encloses a cavity, which receives cooling air supplied from the vane carrier side.

7. The mounting and sealing arrangement as claimed in claim 6, wherein said cooling air is supplied through a bore in said vane carrier.

8. The mounting and sealing arrangement as claimed in claim 1, wherein said intermediate mounting element is provided on its inner side with a circumferential sealing groove, which receives a circumferential seal for sealing said intermediate mounting element against a sealing surface on said outer diameter platform.

9. The mounting and sealing arrangement as claimed in claim 8, wherein said circumferential seal has the form of a corrugated metal strip or a C-shaped metal strip.

10. The mounting and sealing arrangement as claimed in claim 1, wherein said intermediate mounting element is made of a single material or of at least two different materials.

11. The mounting and sealing arrangement as claimed in claim 10, wherein said intermediate mounting element is made of at least two different materials, characterized in that said intermediate mounting element comprises two separate parallel annular and circumferential or segmented sidewalls made of a first material suitable for a first operating temperature, which are connected by equidistant transverse webs made of a second material suitable for a second operating temperature higher than said first operating temperature such that each of said vanes is mounted between two adjacent webs.

12. The mounting and sealing arrangement as claimed in claim 1, further comprising an impingement plate is provided for each of said vanes just above said outer diameter platform for impingement cooling of said outer diameter platform.

13. The mounting and sealing arrangement as claimed in claim 1, wherein said intermediate mounting elements are each provided with hooks for mounting said intermediate mounting elements on said vane carrier.

14. A gas turbine comprising a mounting and sealing element according to claim 1, a vane carrier and a plurality of vanes carried on the vane carrier in a ring-like arrangement, whereby said vanes each comprise an airfoil and an outer diameter platform.
